(19) United States
(12) Patent Application Publication
(10) Pub. No.: US 2013/0159012 A1
(43) Pub. Date: Jun. 20, 2013

(54) QUALIFYING DATA AND ASSOCIATED METADATA DURING A DATA COLLECTION PROCESS

(71) Applicant: Datasci LLC, Olney, MD (US)

(72) Inventors: Kim Nitahara, Somerville, NJ (US); Marc Kozam, Sandy Spring, MD (US); Louis Korman, Rockville, MD (US)

(73) Assignee: Datasci LLC, Olney, MD (US)

(21) Appl. No.: 13/768,828

(22) Filed: Feb. 15, 2013

Related U.S. Application Data
(63) Continuation of application No. 12/621,041, filed on Nov. 18, 2009.
(60) Provisional application No. 61/115,774, filed on Nov. 18, 2008.

(51) Int. Cl. G06F 19/00; G06Q 50/22

(52) U.S. Cl. CPC G06F 19/36; G06Q 50/22
USPC 705/2

(57) ABSTRACT

Systems and methods for processing metadata associated with a clinical trial are described. In one aspect, a computing device receives collected data with embedded metadata. The device extracts the embedded metadata, and accesses a database to determine characteristics of the embedded metadata. The device then accesses protocol rules where the protocol rules are a set of data collection requirements and procedures for a given clinical trial. The device ensures compliance of the embedded metadata by comparing the characteristics of the embedded metadata with the protocol rules. The device then reports the compliance or non-compliance of the collected data.

### PRIORITY CLAIM

This application is a Continuation of U.S. application Ser. No. 12/621,041, filed Nov. 18, 2009, which claims priority to U.S. Provisional Patent Application No. 61/115,774, filed Nov. 18, 2008; the contents of which are incorporated by reference herein in their entirety.

### BACKGROUND

Clinical trials are often required for getting a new medication, medical treatment, and/or medical device approved by a regulatory agency, such as the Food and Drug Administration in the United States.

A clinical trial may be a comparison test of a medication, medical treatment, and/or medical device versus a placebo, other medical treatments and/or medical devices, respectively. A clinical trial may also be a comparison of an alternative treatment versus a standard medical treatment for a particular medical condition. Clinical trials may vary greatly in size: from a single researcher in one hospital or clinic to an international, multi-center study with several hundred participating researchers on several continents. The number of subjects tested can range from a small group to several thousand individuals. The acquisition, validation and processing of such large amounts of data requires careful record keeping and cooperation between different groups.

The safety and effectiveness of a new medication, medical treatment, and/or medical device on humans must be proven by following a clearly defined test procedure that may be described in detail in a clinical trial protocol. A clinical trial protocol is a document that describes the objective(s), design, methodology, statistical considerations, and organization of a clinical trial. The clinical trial protocol may give background and reason(s) the trial is being conducted. The clinical trial protocol contains the study plan, activities to perform, required data to collect, procedures, etc. The study plan may be designed to safeguard the health of the subjects as well as answer specific research questions. The clinical trial protocol may describe, among other things, what types of people may participate in the trial; the schedule of tests, procedures, medications, and dosages; and/or the length of the study. Other clinical trial parameters may also be included. While in a clinical trial, study subjects are seen regularly by research staff to monitor health and determine the safety and effectiveness of the received treatment(s).

After approval of the clinical trial protocol by an ethics committee, a clinical trial investigator may recruit clinical sites and subjects for the clinical trial. Clinical trial personnel may be trained to conduct the clinical trial according to the clinical trial protocol. The necessary procedures may be initiated and clinical data may be generated, stored and validated according to the clinical trial protocol description.

Clinical data may be difficult to handle, monitor and/or validate if the test protocols are carried out in remote and/or diverse locations, such as different countries. Clinical trials may suffer from various other obstacles as well. For example, data collected during a clinical trial may not be collected consistently; data integrity may be compromised at several points in the system; data collection may inadvertently vary; equipment may be replaced; and/or compliance procedures may not be followed during data collection.

The difficulties experienced during clinical trials may be magnified when the clinical trials are conducted on a global scale. Coordinating data collection in several locations in several countries worldwide may pose organizational and administrational challenges. Different regulations, enforcement and standards in different countries may complicate the collection of data compliant with the clinical trial protocol.

Despite the difficulties experienced during global clinical trials, global clinical trials have increased benefits over traditional clinical trials. Global clinical trials may greatly expand the number of patients, medical personnel, and facilities available for a particular clinical trial. Global clinical trials may allow for increased speed or efficiency, cost savings, and/or a more diverse pool of subjects.

In known systems, there is no direct link between the clinical data generation and the clinical trial protocol. In these systems, both a technician that generates the clinical data and an end user of the medical data need to be aware of constraints imposed by the clinical data generation and the clinical trial protocol requirements. Furthermore, both a technician that generates the clinical data and an end user of the medical data need to be trained regarding the constraints imposed by the clinical data generation and clinical trial protocol requirements. Following such procedures over long time periods may be a laborious and time consuming task in which errors are common. Furthermore, data collected may be insufficiently detailed, lack evidence of collection conditions, or be otherwise unacceptable for use in later analysis. Data collected during a clinical trial needs to include verifiable evidence of the data collection conditions.

Current attempts by government regulators to trace data collection are generally unsophisticated. For example, as of October 2008, retailers are required by law to label the country of origin on all fresh produce, meat, poultry and fish sold in the United States. There are, however, no sophisticated or electronic methods for collecting or qualifying the data regarding country of origin. In fact, the Food and Drug Administration in the United States uses stickers on fresh produce to trace origin. Grocery stores have bar code scanners and related technology for nearly every packaged product, but fresh produce still uses basic devices such as stickers that are not highly reliable or verifiable and may be subject to tampering.

Similar difficulties exist in nearly all data collection endeavors, including clinical trials. For example, the Food and Drug Administration in the United States inspects instruments used in clinical trial data collection to ensure that the equipment that was approved for use is the actual equipment being used for data collection. This requires significant oversight by the regulatory authority. This type of information may be difficult to trace without data collection procedures and may be subject to tampering.

### SUMMARY

It is, therefore, an object of certain embodiments of this invention to provide methods and/or systems having beneficial features that enable automation of qualification and confirmation of clinical trial activities, data, and results and permits future objective evaluation of clinical trial results. It is another object of certain embodiments of this invention to validate data through use of embedded data.

Embodiments may include a method implemented by a computing device for processing data associated with a clinical trial, the method including receiving collected data with embedded metadata; extracting the embedded metadata; accessing a database for determining characteristics of the embedded metadata; accessing protocol rules, wherein the protocol rules includes a set of data collection requirements and procedures; ensuring compliance of the embedded metadata by comparing the characteristics of the embedded metadata with the protocol rules; and reporting the compliance or non-compliance of the collected data in real-time, near real-time or other time intervals.

This Summary is provided to introduce a selection of concepts in a simplified form further described below in the detailed description. This Summary is not intended to identify key features or essential features of the claimed subject matter, nor is it intended to be used as an aid in determining the scope of the claimed subject matter. Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate the invention and together with the detailed description serve to explain the principles of the invention. In the drawings:

FIG. 1 is a flow chart of an exemplary method and system for compliance monitoring.

FIG. 2 is a flow chart of an exemplary method and system for reviewing clinical trial or other data collection proposals.

FIG. 3 is a flow chart of an exemplary method and system for performing a clinical trial.

FIG. 4 is a flow chart of an exemplary method and system for data validation.

### DETAILED DESCRIPTION

Data may be qualified at an initial point of contact to facilitate management of a clinical trial or other data acquisition processes. Clinical trials are merely an exemplary use of the methods and systems described in the specification. Computer processors, hardware and software may be configured to perform the methods and systems as described herein. The methods described herein may be stored in a computer-readable storage medium and/or computerized memory.

Each piece of clinical data collected during a clinical trial may preferably be characterized by metadata. As indicated above, data collected for clinical trials must be in compliance with a clinical trial protocol. A clinical trial protocol designed by an investigator may include any or all of the following: (1) data for collection, i.e., values and/or requirements for validity, (2) equipment requirements and specifications, (3) personnel requirements and qualifications, (4) interventions to perform, and (5) endpoints, i.e., time, outcome, and/or adverse events. Other types of data may be possible. Metadata may facilitate methods and systems for complying with the clinical trial protocol.

Metadata may allow end users of the clinical data to determine if the clinical data itself is in compliance with the clinical trial protocol. For example, a measurement may only be used if the measurement was obtained using approved equipment, the equipment was appropriately calibrated and serviced, personnel approved for the task performed the work, and the measurements had been obtained at appropriate intervals. Other requirements may be necessary depending on the particular clinical trial protocol. Metadata may store this necessary information for access by an end user of the clinical data.

Metadata may be, for example, but not limited to, information regarding the source, time, date, location, patient, equipment, medical professionals, measurement units, clinical trial, etc. Confidence in the data may be improved by data links to the source of the information. Metadata for dates may include values and/or validity. Metadata for personnel may include names, roles, validity, qualifications, and/or recertification due dates. Metadata for subjects may include names and/or validity, such as unique identifiers, identification codes, bar codes, and/or biometrics.

Metadata for equipment may include, for example, name of the equipment, manufacturer, model, method of data entry, i.e., automated, semi-automated, manual, validity, accuracy, the date of last calibration, when recalibration is due, service records, technician operating the equipment, certification of the technician, etc. As a further example, a patient blood pressure measurement may contain metadata directed to when the blood pressure measurement was obtained, which device was used to make the blood pressure measurement, and which personnel used the equipment. The metadata may also include more specific information on the blood pressure cuff equipment, such as, manufacturer, model, serial number, calibration records, service records, and/or staff trained to use the equipment. As an alternative to storing actual information in the metadata, pointers to the actual data may be stored in the metadata that refer the end user of the data to the actual information. The actual information may be stored in a database or other computer-readable medium.

Metadata may include information regarding informed consent. Informed consent is a legal condition whereby a person can be said to have given consent based upon an appreciation and understanding of the facts and implications of an action. The individual needs to be in possession of relevant facts and also of his reasoning faculties, such as not being mentally retarded or mentally ill and without an impairment of judgment at the time of consenting. Informed consent information in clinical trials may assist in validation of clinical trial data because the information regarding informed consent may be stored with the clinical trial data for use during validation. The storage of the information regarding informed consent may be stored such that the informed consent is legally enforceable. The storage of the information regarding informed consent may be stored to comply with one or more standards used internationally. Metadata may be stored with the clinical data such that the metadata resists tampering.

Metadata may further incorporate biometric information, such as, but not limited to, fingerprints, face image recognition, retinal imaging, etc. Biometric information may be useful to confirm patient existence and other information. Biometric information may also be tamper-resistant.

Metadata from the clinical trial may be used to validate the clinical trial data. Including validity metadata with clinical trial data may allow for reliable, standardized data and may facilitate clinical trial management. Clinical data may be monitored and validated in real-time and/or via remote access. Time spent on clinical trial monitoring may be reduced due to data processing efficiency and reduction of paperwork. Methods and systems using metadata for clinical trial data may also allow for adaptive clinical trials. Adaptive clinical trials may be beneficial in that they can be adjusted as information becomes available to facilitate a beneficial outcome. For example, dosages of medication may be adjusted based upon results found from previous dosage amounts. This may increase the effectiveness of a clinical trial by addressing notable trends in the data prior to the end of the clinical trial and without requiring a new clinical trial. Contemporaneous collection and qualification of data may allow for real-time availability of information.

Methods and systems may provide for standardized metadata formats. Standardized formats may allow for use of the metadata by diverse operating platforms. Standardized interfaces may allow for use by many different end user applications. Data analysis may be pushed into an implementation phase.

An exemplary method and system may be provided for ensuring validity of data in a clinical trial. In a startup phase, protocols may be developed and databases may be created. Databases may include sub-databases for personnel, equipment, measurements, interventions and/or subjects. As a clinical trial or other data collection process proceeds, continual checks may be had for compliance with recertification requirements. Databases may be regularly or periodically updated. During pre-measurement events, proposed measurements, subjects, personnel, sites, dates, equipment, etc. may be checked against a protocol-based rule engine to determine if all elements are compliant. The protocol-based rule engine may determine if the proposed elements are accepted or rejected. If the proposed elements are accepted, measurements may be taken. As a post-measurement procedure, the elements may be re-verified with a data validity rule engine. The data-validity rule engine may determine if the measurements are accepted or rejected.

An intervention may be a medical or therapeutic action taken relative to a patient. During a pre-intervention event, proposed interventions, subjects, personnel, sites, dates, equipment, etc. may be checked against the protocol-based rule engine. The protocol-based rule engine may determine if the intervention proceeds or is stopped. If the proposed intervention proceeds, a post-intervention analysis may include re-verification with the protocol-based rule engine. Intervention information may then be recorded.

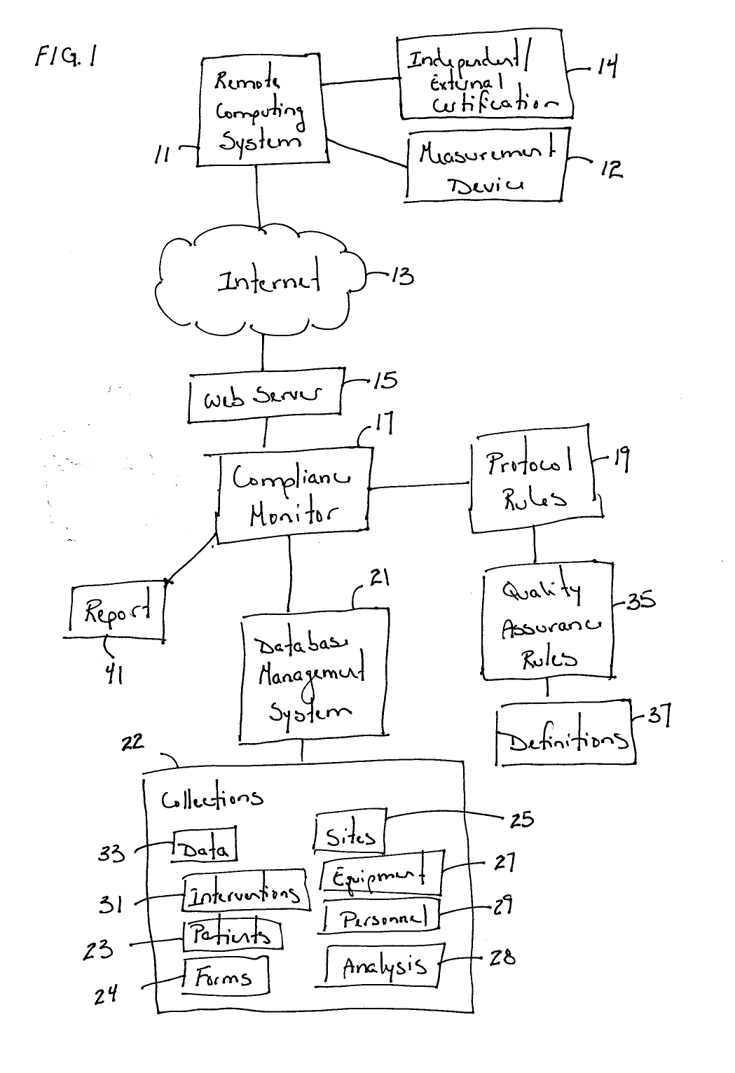

FIG. 1 illustrates an exemplary method and system for compliance monitoring. An investigator may operate a remote computer system 11 at a remote site for collecting data. A measurement device 12 may supply information to the remote computer system 11. The remote computer system 11 may also accept input from an independent and/or external qualification system 14. The independent and/or external qualification system 14 may include time stamps to prove times, electronic signature certification, International Standards Organization and other standard setting organization certification, instrument identifiers, global positioning information to verify location, biometric certification to verify identities, image recording devices to produce visual evidence, etc. The remote computer system 11 may access a web server 15 over a network, such as the Internet 13 or other networks. The remote computer system 11 may access the web server 15 from an enabled browser at the remote computer system 11. The web server 15 may be in communication with a compliance monitor or rules engine 17. The compliance monitor 17 may be automated and stored in a tangible, computer storage medium. Clinical trial rules and protocols 19 may be entered into the compliance monitor 17. Protocol rules 19 may include quality assurance rules 35. The quality insurance rules 35 may in turn include definitions 37. The compliance monitor 17 may be in communication with a database 21/database management system. The database 21 may be one or more associated databases.

The database 21 may contain information categorized in one or more collections 22 related to subjects including, but not limited to, patients 23, forms 24, sites 25, equipment 27, analysis 28, personnel 29, interventions 31 and/or clinical data 33. The database 21 may be managed by a database management system and administrator. The database 21 may be a single database and/or a series of related databases. A sub-database or collection may contain equipment and services information. This database may include unique equipment/service identifiers, names of equipment/services, models, serial numbers, accuracy ratings, and/or certification requirements, such as service records and/or recertification records. Another sub-database may be a personnel database. This database may include unique personnel identification, names, contacts, measurements qualified by identifier, such as qualifications and/or recertification records, and/or interventions qualified by identifier, such as qualifications and/or recertification records. Yet another sub-database may be a subject database. This database may include unique subject identifiers, names, genders, dates of birth, biometric identifiers, and/or site affiliation by identifier. Another sub-database may be a site database. This database may include unique site identifiers, location, contacts, physical facility requirements, subjects enrolled by identifiers, equipment available by identifiers, personnel available by identifiers, and/or interventions available by identifiers. An additional sub-database may be a measurement database. This database may include unique measurement identifiers, names, equipment allowed by identifiers, personnel qualified by identifiers, minimum/maximum frequency measured, value (potentially on a scale), and/or validity needed (potentially on a scale). Another sub-database may be an intervention database. This database may include unique intervention identifiers, names, equipment needed by identifiers, personnel qualified by identifiers, and/or minimum/maximum frequency performed. The database may also include various forms and analysis methods and results.

The compliance monitor 17 may also generate and/or output reports 41. Notification may also be given to an investigator of the compliance or non-compliance of the clinical trial data.

During data collection, the compliance monitor 17 may facilitate collection of data relating to a clinical trial. A remote user may propose to enter measurements taken by the measurement device 12. The measurements may be, but are not limited to, laboratory values or clinical observations. The proposed entry of measurements may include metadata information such as, but not limited to, equipment to be used, potential observers, and/or patient information. The compliance monitor 17 may use the protocol rules 19 to determine if the metadata information is in compliance with the clinical trial quality assurance rules 35. If the metadata information is in compliance with the clinical trial quality assurance rules 35, then the remote user may be advised to collect data. Otherwise, the remote user is advised that the metadata information/proposal to enter measurements is not in compliance with the clinical trial quality assurance rules 35. After data is collected, the data may be submitted by the remote user for entry into a database 43. Prior to actual entry of the data into the database 43, the data itself may be validated against existing database entries and other validity checks. If successful, the data and the associated metadata are entered into the database 43. If unsuccessful, an opportunity to correct the data and the associated metadata may be provided. If the corrected data and the associated metadata are then acceptable, the data and the associated metadata may be entered into the database. Upon completion of a data collection activity, the compliance monitor may advise users and subjects regarding the next scheduled data collection or intervention activity, possibly as a result of protocol specifications that may take recent or prior data collection into account.

The compliance monitor 17 may also be used to facilitate collection of data relating to a clinical trial when recording an intervention. A remote user may propose to perform an intervention, such as, but not limited to, administering a medication or treatment. The proposal to perform an intervention may include metadata information such as, but not limited to, equipment, personnel, and/or patients. The compliance monitor 17 may use protocol rules 19 to determine if the intervention is appropriate and if the metadata information is in compliance with the quality assurance rules 35 relating to the proposed intervention. If the metadata information is in compliance with the clinical trial quality assurance rules 35, then the remote user may be advised to perform the intervention. Otherwise, the remote user is advised not to perform the intervention. The remote user may then indicate that the intervention has or has not occurred. Upon completion of an intervention, the compliance monitor may advise users and subjects regarding the next scheduled data collection or intervention activity.

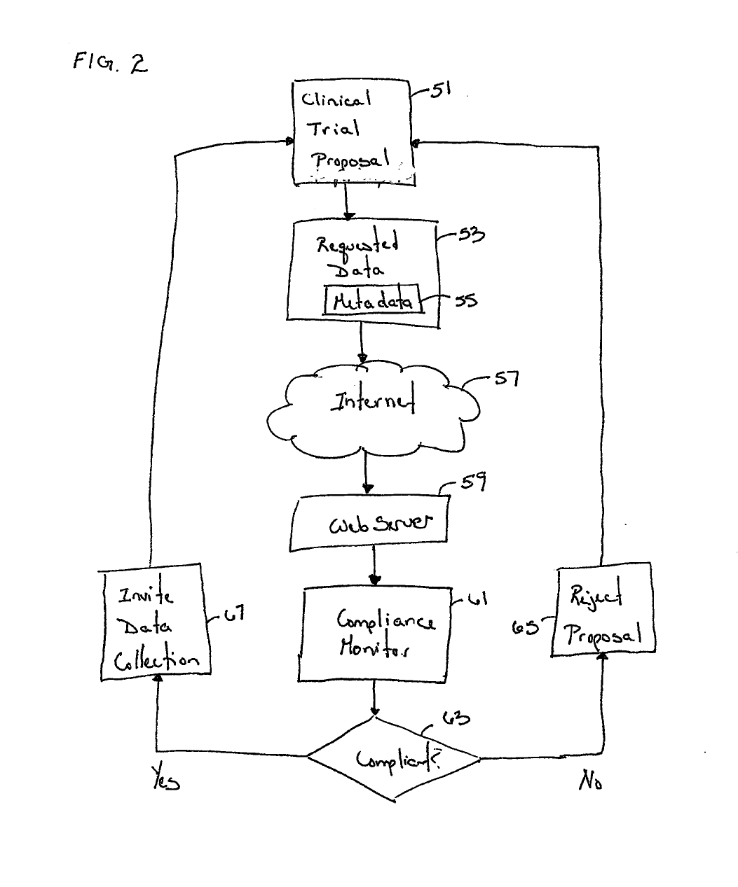

FIG. 2 illustrates an exemplary method and system for reviewing clinical trial or other data collection proposals. A clinical trial proposal 51 for participation may be developed. The clinical trial proposal 51 may include various types of requested data 53 with corresponding metadata 55. The metadata 55 may include, for example, equipment identification, investigator identification, personnel identification, data and/or subject. The clinical trial proposal 51 may be submitted to a web server 59 over the Internet 57. The web server 59 may be in communication with a compliance monitor 61. The compliance monitor 61 may determine if the clinical trial proposal is compliant 63. The compliance monitor 61 may determine if the metadata 55 is valid. For example, the compliance monitor 61 may determine if the equipment data and/or personnel data matches the required criteria. If the clinical trial proposal is not compliant, the clinical trial proposal is rejected 65. A notification may be sent to the developer of the clinical trial proposal. If the clinical trial proposal is compliant, an invitation to collect data 67 may be sent to the developer of the clinical trial. The invitation 67 may include approval to begin data collection activities and/or begin data submissions.

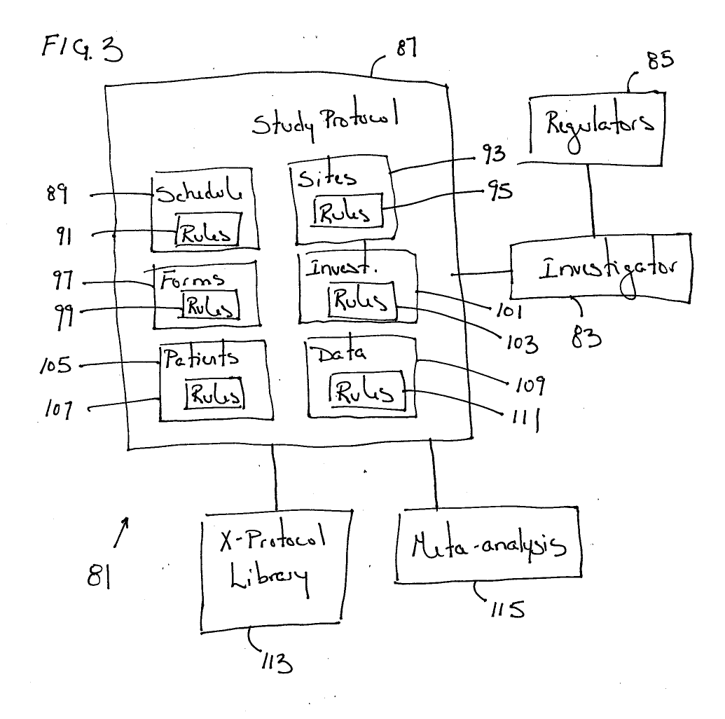

FIG. 3 illustrates an exemplary method and system for performing a clinical trial 81. A clinical trial 81 may be initiated by an investigator 83. An investigator may collect and/or process measurements from data sources. Regulators 85 may determine the rules, requirements and procedures for investigators 83. The study and data protocols may be governed by regulators 85, such as an institutional review board or other type of regulatory agency. An institutional review board and/or independent ethics committee may be a group that has been formally designated to approve, monitor, and review biomedical and behavioral research involving humans with the alleged aim to protect the rights and welfare of the subjects. An institutional review board performs critical oversight functions for research conducted on human subjects that are scientific, ethical, and regulatory.

The clinical trial 81 may be characterized by a study protocol 87. The study protocol 87 may record various types of data and associated rules. For example, possible data may include schedules 89 with schedule rules 91, sites 93 with site rules 95, forms 97 with form rules 99, investigators 101 with investigator rules 103, patients 105 with patient rules 107, and/or data 109 with data rules 111. Other types of data and associated rules are possible. An X-protocol or other similar type of library 113 may create and/or store rules for use in the study protocol 87. Meta-analysis 115 may be performed on data within the study protocol 87.

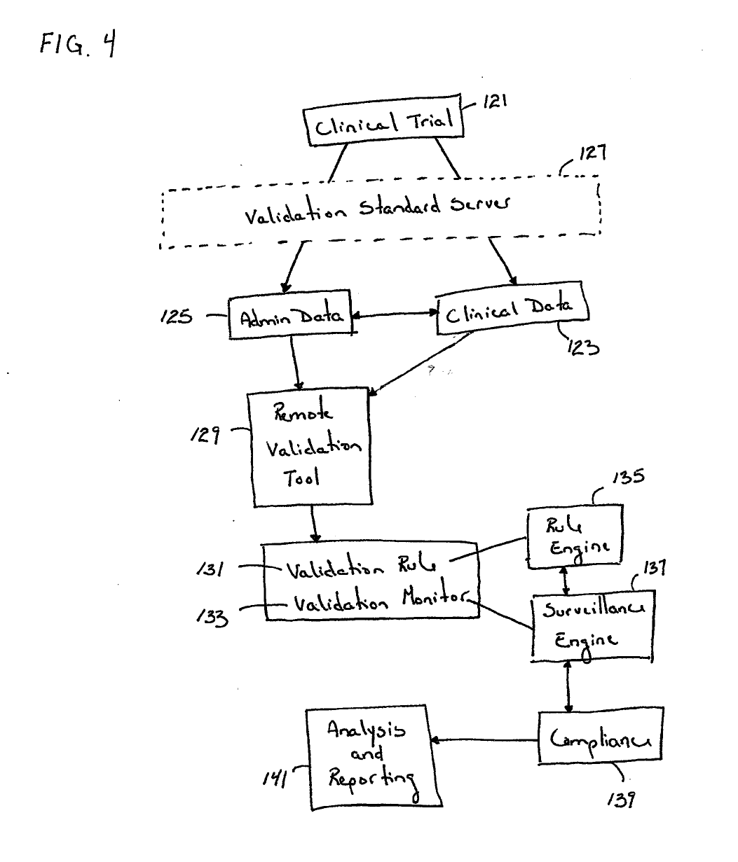

FIG. 4 illustrates an exemplary method and system for data validation. A clinical trial 121 may collect clinical data 123. The clinical trial 121 may also collect administrative data 125 for the clinical data 123 based upon a validation protocol. Data from the clinical trial 121 may pass through a validation standard server 127 prior to recordation and/or processing. The administrative data 125 may be passed to a remote validation tool 129. The remote validation tool 129 may apply a validation rule 131 and/or a validation monitor 133 to the administrative data 125. The validation rule 131 may be governed by a rule engine 135. The validation monitor 133 may be governed by a surveillance engine 137. The rule engine 135 and/or the surveillance engine 137 may be in communication with a compliance monitor 139. The compliance monitor 139 may allow for data analysis and reporting 141. Data from the clinical trial 121 may be transformed by the embedding of metadata and subsequent processing by the validation rule 131 and/or the validation monitor 133. Furthermore, the data may be transformed by the data analysis and reporting 141.

The above-described exemplary embodiments of systems and methods for qualifying data and associated metadata during a data collection process is presented for illustrative purposes only. While this invention is satisfied by embodiments in many different forms, it is understood that the present disclosure is to be considered as exemplary and is not intended to limit the described systems and methods to the specific embodiments illustrated and described herein. Numerous variations may be made by persons skilled in the art without departure from the spirit of this description. Moreover, features described in connection with one embodiment may be used in conjunction with other embodiments, even if not explicitly stated above. The scope of the invention will be measured by the appended claims and their equivalents. The abstract and the title are not to be construed as limiting the scope of the claims, as their purpose is to enable the appropriate authorities, as well as the general public, to quickly determine the general nature of the described systems and methods. In the claims that follow, unless the term “means” is used, none of the features or elements recited therein should be construed as means-plus-function limitations pursuant to 35 U.S.C. §112, ¶6.

1. A method implemented by a computing device for processing metadata associated with a clinical trial, the method comprising:
receiving a clinical trial data collection proposal with embedded metadata;
extracting the embedded metadata;
accessing a database for determining characteristics of the embedded metadata;
accessing protocol rules, wherein the protocol rules comprise a set of clinical trial requirements and procedures;
ensuring compliance of the embedded metadata, by at least one processor component, by comparing the characteristics of the embedded metadata with the protocol rules; and
reporting the compliance or non-compliance of the data collection proposal prior to receiving collected data related to the clinical trial data collection proposal.

2. The method of claim 1, wherein the database further comprises a series of sub-databases for each characteristic.

3. The method of claim 1, wherein the protocol rules further comprise quality assurance rules and definitions.

4. The method of claim 1, wherein the data collection proposal is received from a remote client computer.

5. The method of claim 1, wherein the method raises a level of compliance with the protocol rules in the clinical trial.

6. The method of claim 1, wherein the metadata comprises information about sites, documents, personnel, equipment, patients, and interventions.

7. The method of claim 1, wherein the metadata comprises informed consent information.

8. The method of claim 1, wherein the metadata has a standard interface format.

9. The method of claim 1, wherein the clinical trial is overseen by an institutional review board.

10. The method of claim 1, further comprising monitoring the collected data in real-time.

11. The method of claim 1, further comprising monitoring the collected data throughout the clinical trial.

12. The method of claim 1, further comprising providing notification of compliance or non-compliance to an investigator.

13. The method of claim 1, further comprising:
receiving the collected data with procedural information embedded as metadata;
ensuring compliance of the procedural information with one or more database entries or validity checks.

14. The method of claim 13, wherein if the procedural information is compliant, then entering the collected data and procedural information into a database.

15. The method of claim 13, wherein if the procedural information is not compliant, then providing an opportunity to correct the procedural information.

16. The method of claim 13, further comprising advising on a next scheduled data collection or intervention activity.

17. The method of claim 1, wherein the clinical trial data collection proposal is an intervention.

18. The method of claim 1, further comprising re-verifying the collected data with a data validity rule engine after data collection.

19. A data processing system for processing metadata associated with a clinical trial, the data processing system comprising:
a data processing device comprising at least one processor component and a memory; and
wherein the data processing device:
receives data from a client computer, wherein the data comprises clinical data and administrative data, wherein the administrative data is embedded within the data as metadata,
extracts the administrative data,
determines compliance of the administrative data with a clinical trial data acquisition protocol, and
if compliant, enters the data in a database or record as clinical trial data, or if not compliant, provides an opportunity to correct the administrative data before entering the data in the database or record as clinical trial data.

20. The data processing system of claim 19, further comprising a database for storing information related to characteristics of the administrative data.

21. The data processing system of claim 20, wherein the data processing device accesses the database for determining compliance of the administrative data with the clinical data acquisition protocol.

22. The data processing system of claim 20, wherein the database is a series of sub-databases for each characteristic of the administrative data.

23. The data processing system of claim 19, wherein the administrative data is a pointer to actual information.

24. The data processing system of claim 19, wherein the data processing device reports compliance or non-compliance of the administrative data with the clinical trial data acquisition protocol.

25. A computer readable data storage medium comprising computer-program instructions executable by at least one processor component, the computer-program instructions, when executed by the at least one processor component, for implementing steps comprising:
embedding procedural information regarding acquisition of clinical trial data into a clinical trial data collection proposal as metadata;
sending the clinical trial data collection proposal to a remote validation tool;
receiving a determination of compliance of the procedural information with protocol rules prior to data collection.

26. The computer readable data storage medium of claim 25, further comprising sending the clinical trial proposal to a surveillance engine.

27. The computer readable data storage medium of claim 26, wherein the surveillance engine is in communication with a compliance monitor.

28. The computer readable data storage medium of claim 25, further comprising sending collected data with procedural information embedded as metadata.

29. The computer readable data storage medium of claim 25, wherein if the procedural information is not compliant, then sending a corrected clinical trial proposal.

30. The computer readable data storage medium of claim 25, wherein the metadata is encoded to be accessible to systems receiving the clinical trial proposal.
